(19) United States
(12) Patent Application Publication
(10) Pub. No.: US 2006/0157875 A1
(43) Pub. Date: Jul. 20, 2006

(54) Method of manufacturing a replica, as well as a replica obtained by carring out a uv light-initiated or thermal curing treatment of a reactive mixture

(75) Inventors: Helmar Van Santen, Eindhoven (NL); Hendrik Roelof Stapert, Eindhoven (NL); Johan George Kloosterboer, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/538,106

(22) PCT Filed: Nov. 26, 2003
(86) PCT No.: PCT/IB03/05435

§ 371 Date: Jun. 8, 2005

(30) Foreign Application Priority Data
Dec. 13, 2002 (EP) 02080272.4

(51) Int. Cl. B29D 17/00; B32B 3/02

(52) U.S. Cl. 264/1.33; 428/64.1

(57) ABSTRACT

The present invention relates to a method of manufacturing a replica, which method comprises the provision of a curable resin composition between a mold and a substrate or a blank, carrying out a UV light-initiated or thermal curing treatment and removing the replica thus manufactured from the mold, which replica comprises the substrate and the reproduction of the mold provided thereon. The invention also relates to a replica obtained by carrying out a UV light-initiated or thermal curing treatment of a reactive compound, especially a replica that has a high transparency for low wavelengths, i.e. 190-400 nm.

The present invention relates to a method of manufacturing a replica, which method comprises the provision of a curable resin composition between a mold and a substrate or a blank, carrying out a UV light-initiated or thermal curing treatment and removing the replica thus manufactured from the mold, which replica comprises the substrate and the reproduction of the mold provided thereon. The invention also relates to a replica obtained by carrying out a UV light-initiated or thermal curing treatment of a reactive mixture or composition, especially a replica that has a high transparency for low wavelengths, i.e. 190-400 nm.

Replication molding techniques are well known. In such a technique, a replica mold having a surface which is a negative copy of a surface of the final product is first prepared from a master mold. The final product is then molded against the negative surface of the replica mold, thus reproducing the surface configuration of the master mold.

Such a method is known per se from U.S. Pat. No. 4,890,905, filed in the name of the current applicant. The replication process employs a mold or a matrix having an accurately defined surface which is the negative of the desired optical profile of the replica In the exact determination of the definition of the surface of the mold or matrix, the shrinkage of the synthetic resin of the replica must be taken into account. A small quantity of a liquid, curable synthetic resin composition is provided on the surface of the mold. The substrate, which may or may not be transparent to UV light, is subsequently pressed with the desired side against the mold, or the mold is pressed against the substrate, as a result of which the synthetic resin spreads between the surface of the substrate and the surface of the mold. Said liquid, synthetic resin composition may be provided on the substrate instead of the mold. The synthetic resin mixture is cured and the substrate with the cured synthetic resin layer bonded thereto is removed from the mold. The free surface of the synthetic resin layer is the negative of the corresponding surface of the mold. The advantage of the replication process is that optical components, such as lenses having a complicated refractive surface, for example an aspherical surface, can be manufactured in a comparatively simple manner without subjecting the substrate to complex polishing treatments. A drawback of such a replication by means of polymerization is the occurrence of shrinkage. Particularly if the flow of the bondable resin composition is impeded by gelation or a substantial increase in viscosity due to the polymerization, further polymerization will lead to the development of stresses or even to premature delamination. If the product is subsequently removed from the mold, as in the case of, in particular, a replication process, only a partial relaxation of the stresses takes place, particularly if the product formed is composed of a densely bonded polymeric network. Such a bonded polymeric network is desired, however, for the cohesion of the product formed.

The criticality of the polymeric composition used to form replica molds has been confirmed by many unsuccessful attempts to obtain accurate replications of glass surfaces using a multitude of commercially available resins to form the replica molds.

For example, low-melting polyethylenes appear to form microscopic defects in the mold surfaces which reproduce in the final plastic lenses. Also, these materials are not believed to be sufficiently rigid and stiff to prevent distortion of the curing plastic lens. On the other hand, materials such as linear polymethyl methacrylate produce replica molds whose surfaces are solvent attacked by one of the materials primarily used in forming plastic lenses. A solvent attack of this nature produces a matte finish on the final plastic lens making it unsatisfactory.

Another property which makes some polymeric materials unacceptable is their release characteristics from the plastic lens being molded.

Basic optical properties such as high light transmittance, high refractive index, low residual birefringence after molding, and the like are required for geometrical optical lenses which are employed in various cameras such as common cameras, single use cameras, video cameras, and the like, optical recording units such as CD, CD-ROM, CD-Video, MO, CD-R, DVD, Blue Ray and the like, as well as OA equipment such as copiers, printers, and the like. In addition, general properties such as high thermal stability, high mechanical strength as well as hardness, low water absorption, high weather resistance, high solvent resistance, and the like are also required. Further, for production at low cost, excellent moldability is required.

An optical element having the aforementioned basic optical properties is known per se from U.S. Pat. No. 6,285,513, comprising:

a silicon based resin satisfying following conditional formulas:

(number of silicon atoms residing as R1SiO_{3/2} in the silicon based resin)/(total number of silicon atoms in the silicon based resin)≧20,

(number of silicon atoms residing as SiO_{4/2} in the silicon based resin)/(total number of silicon atoms in the silicon based resin)≧20,

(number of silicon atoms residing as R1SiO_{3/2} in the silicon based resin)+(number of silicon atoms residing as SiO_{4/2} in the silicon based resin}×100/(total number of silicon atoms in the silicon based resin)≧10%

wherein R1 represents a hydrogen atom, a hydroxyl group, an amino group, a halogen atom or an organic group.

The optical elements comprised of the aforementioned curable silicon resins may be molded employing molding methods such as injection molding, extrusion molding, pouring type molding and the like. In order to obtain the desired low birefringence, molding is preferably carried under no pressure application, if possible. As disclosed in the Examples the resulting silicone resin composition was injected into a lens molding dye at 40 atmospheric pressure and heated at about 150° C. In the application of UV and deep-UV, disadvantage of the optical elements made in the aforementioned way may be that transmission can be too low due to the long optical path through the component.

It is the objective of this invention to provide a method of manufacturing optical components through replication on a UV or deep-UV transparent glass, herewith greatly improving transmission for UV and deep-UV.

It is an object of the invention to provide a method of manufacturing a replica wherein a reactive material having a sufficient transmission for UV and deep-UV is applied.

Another object of the invention is to provide a method of manufacturing a replica wherein a material is used that easily can be replicated and that is relatively insensitive to (deep) UV light.

Yet another object of the invention is to provide a replica obtained by carrying out a UV light-initiated or thermal curing treatment of a reactive compound, wherein a sufficiently good aspherical element is obtained.

The method mentioned in the opening paragraph is characterized in accordance with the invention that the resin composition used being a silicon based reactive material.

The resin composition according to the invention comprises

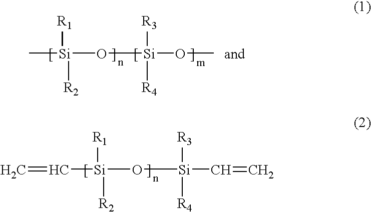

wherein R₁, R₂, R₃, R₄=hydrogen, C₁-C₁₀-alkyl, vinyl, phenyl, hydroxide, amino, halogen atom and at least one of R₁, R₂, R₃ and R₄ is hydrogen.

In a preferred embodiment of the present invention the resin composition further comprises

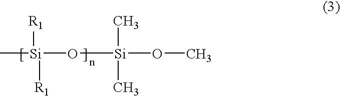

wherein R₁, R₂, R₃ and R₄ have the same meaning as already disclosed before.

In addition it is preferred that the resin composition further comprises

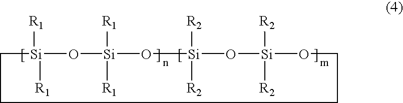

wherein R₁, R₂, R₃ and R₄ have the same meaning as already disclosed before.

It is to be noted that the resin composition also comprises a metal catalyst, e.g. a platinum based catalyst, in an amount of 5-10 ppm Pt.

It is preferred that component (1) is present in an amount of 40-70 wt. %, based on the total weight of the curable resin composition.

In addition, it is preferred that component (2) is present in an amount of 15-40 wt. %, based on the total weight of the curable resin composition.

Furthermore it is preferred that component (3) is present in an amount of 10-30 wt. %, based on the total weight of the curable resin composition.

It is preferred that component (4) is present in an amount of 1.0-5.0 wt. %, based on the total weight of the curable resin composition.

The invention further relates to a replica obtained by carrying out a UV light-initiated or thermal curing treatment of a mixture comprising a silicon based reactive material, wherein the resin composition comprises the aforementioned components (1) and (2). Additional embodiments of the present invention are disclosed in the appending claims.

In order to obtain the aforementioned objects according to the invention the transparency of the replica obtained is at least 20%, when replicated on a glass material being transparent for the applied wavelength, measured at a thickness of 100 μm, an intensity of 100 μW/cm² and a wavelength of 190-400 nm, during a period of at least 50 hours.

In a preferred embodiment the transparency of the replica according to the invention is at least 90%, when replicated on a glass material being transparent for the applied wavelength, measured at a thickness of 100 μm, an intensity of 0.5 mW/cm² and a wavelength of 190-400 nm, during a period of at least 5000 hours.

The optical component obtained according to the invention is an (a)spherical lens, a lens array, a prism, a grating or another relief structure for optical applications, or a combination thereof, wherein the replica is characterized in that it is not birefringent.

These and other aspects of the invention will be apparent from and elucidated with reference to a preferred embodiment described hereinafter.

### EXAMPLE

A hemispheric cylinder lens with a radius of 4 mm made of Sylgard 184 (trademark of Dow Chemicals, a mixture of components (1)-(4)) has at a wavelength of 257 mn and an intensity of 500 microWatt/cm², an initial transmission of only 5% which decreases within several hours to below 1%. A layer of 100 micron of the same material replicated on UV transparent quartz lens results in an optical element which at the same dose and wavelength has a transmission of 80% over a period of several days.

1. A method of manufacturing a replica, which method comprises the provision of a curable resin composition between a mold and a substrate or a blank, carrying out a UV-light initiated or thermal curing treatment and removing the replica thus manufactured from the mold, which replica comprises the substrate and the reproduction of the mold provide thereon, characterized in that, the resin composition used being a silicon based reactive material.

2. A method as claimed in claim 1, characterized in that the resin-composition comprises 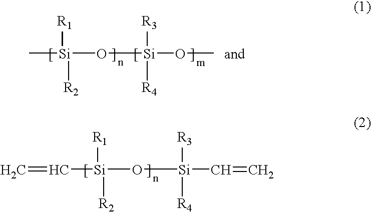
wherein R₁, R₂, R₃, R₄=hydrogen, C₁-C₁₀-alkyl, vinyl, phenyl, hydroxide, amino, halogen atom, and at least one of R₁, R₂, R₃ and R₄ is hydrogen.

3. A method as claimed in claim 2, characterized in that the resin composition further comprises 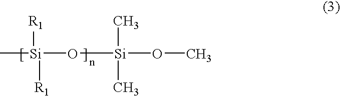
wherein R₁, R₂, R₃ and R₄ have the same meaning as disclosed in claim 2.

4. A method according to claim 2, characterized in that the resin composition further comprises 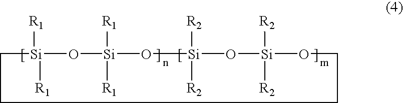
wherein R₁, R₂, R₃ and R₄ have the same meaning as disclosed in claim 2.

5. A method according to claim 2, characterized in that component (1) is present in an amount of 40-70 wt. %, based on the total weight of the curable resin composition.

6. A method according to claim 2, characterized in that component (2) is present in an amount of 15-40 wt. %, based on the total weight of the curable resin composition.

7. A method according to claim 2, characterized in that component (3) is present in an amount of 10-30 wt. %, based on the total weight of the curable resin composition.

8. A method according to claim 2, characterized in that component (4) is present in an amount of 1.0-5.0 wt. %, based on the total weight of the curable resin composition.

9. A replica obtained by carrying out a UV light-initiated or thermal curing treatment of a mixture comprising a silicon based reactive material.

10. A replica as claimed in claim 9, characterized in that the silicon based reactive material comprises 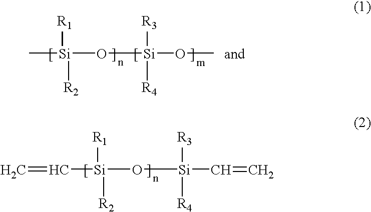
wherein R₁, R₂, R₃, R₄=hydrogen, C₂-C₁₀-alkyl, vinyl, phenyl, hydroxide, amino, halogen atom, and at least one of R₁, R₂, R₃ and R₄ is hydrogen.

11. A replica as claimed in claim 10, characterized in that the silicon based reactive material further comprises 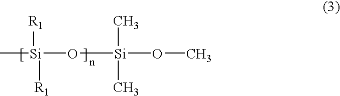
wherein R₁, R₂, R₃ and R₄ have the same meaning as disclosed in claim 10.

12. A replica as claimed in claim 10, characterized in that the silicon based reactive material further comprises 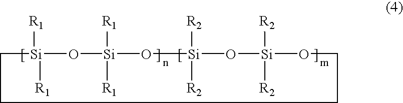
wherein R₁, R₂, R₃ and R₄ have the same meaning as disclosed in claim 10.

13. A replica as claimed in claim 9, characterized in that its transparency is at least 20%, when replicated on a glass material being transparent for the applied wavelength, measured at a thickness of 100 μm, an intensity of 100 μW/cm² and a wavelength of 190-400 nm, during a period of at least 50 hours.

14. A replica as claimed in claim 9, characterized in that its transparency is at least 90%, when replicated on a glass material being transparent for the applied wavelength, measured at a thickness of 100 μm, an intensity of 0.5 mW/cm² and a wavelength of 190-400 nm, during a period of at least 5000 hours.

15. A replica as claimed in claim 9, characterized in that it is not birefringent.

16. A replica as claimed in claim 9, characterized in that the replica obtained is an optical component.

17. A replica as claimed in claim 16, characterized in that the optical component obtained is an (a) spherical lens, a lens array, a prism, a grating or another relief structure for optical applications, or a combination thereof.
